(19) United States
(12) Patent Application Publication
(10) Pub. No.: US 2018/0267879 A1
(43) Pub. Date: Sep. 20, 2018

(54) MANAGEMENT COMPUTER, PERFORMANCE MONITORING METHOD, AND COMPUTER SYSTEM

(71) Applicant: Hitachi, Ltd., Tokyo (JP)

(72) Inventors: Maki TSUDA, Tokyo (JP); Shigeru HORIKAWA, Tokyo (JP); Kousuke SHIBATA, Tokyo (JP)

(73) Assignee: Hitachi, Ltd., Tokyo (JP)

(21) Appl. No.: 15/759,836

(22) PCT Filed: Aug. 9, 2016
(86) PCT No.: PCT/JP2016/073427

§ 371 Date: Mar. 14, 2018

(51) Int. Cl. G06F 11/34

(52) U.S. Cl. CPC G06F 11/3495; G06F 9/45558; G06F 11/3452

(57) ABSTRACT

A management computer that monitors the performance of the components of the computer system includes attribute information for storing characteristic information of the component, component related information for storing the connection relationship between the components, dynamic threshold value calculation information set for each performance information of the constituent elements, and performance related information set with characteristic information of the components related to the performance information. Upon receiving the component to be added or updated, the management computer updates the attribute information and the component related information, determines the combination of the component and the characteristic information based on the component related information and the attribute information, and determines the characteristic calculates the similarity of the information, acquires a dynamic threshold calculation method set for the components which similarity of the characteristic information satisfies a predetermined condition, and obtains the dynamic threshold value calculation method of the received components.

### BACKGROUND

The present invention relates to a technology for monitoring the performance of a computer system.

For a method to detect failure by monitoring the performance of an IT infrastructure system, a monitoring method with a static threshold value in which a setting value is fixed is widely used. For more advanced monitoring, the technology of dynamic threshold monitoring is known (see Japanese Patent Application Laid-open Publication No. 2013-229064, for example). In Japanese Patent Application Laid-open Publication No. 2013-229064, a system operation control device is configured to perform failure detection by providing criteria for detecting failure in the future based on the correlation model of the performance information.

### SUMMARY

In the dynamic threshold value monitoring, it is necessary to collect performance information in an environment where the performance of the computer system is kept stable for a prescribed period of time, until an appropriate threshold value is calculated. However, in a modern IT system infrastructure, configuration changes such as adding virtual machines or virtual volumes are frequently made to meet customer needs. Thus, there are some cases where a new configuration change is made before an appropriate threshold value is calculated in the management computer, which makes it impossible to obtain an appropriate threshold value.

This problem has created the need of shortening the time period required for calculating an appropriate threshold value. In order to fulfill such a need, some IT infrastructure control products require users to input a threshold value calculation method and a parameter such as an initial value. The user needs to select a dynamic threshold value calculation method and parameter based on the properties and configuration of the device, and whether appropriate settings can be made or not would depend on the amount of experiences the user has.

The present invention was made in view of the problems described above, and it is aiming at shortening the time period required to calculate an appropriate threshold value and ensuring that appropriate settings of the dynamic threshold value calculation method and parameter are made regardless of the experiences of the user.

A representative aspect of the present disclosure is as follows. A management computer that comprises a processor and a memory and that is configured to monitor performance of components of a computer system, the management computer including: attribute information that stores therein characteristic information of the components; component related information that stores therein a connection relationship between the respective components; threshold value information that stored therein a threshold value for each performance information of the respective components; dynamic threshold value calculation information that stores therein in advance a dynamic threshold value calculation method for dynamically updating the threshold value for each performance information of the respective components; and performance related information that stores therein in advance characteristic information of components related to the performance information, wherein the processor receives a component to be added or updated, and updates the attribute information and the component related information, wherein the processor determines combinations of components and characteristic information based on the component related information and the attribute information and calculate similarity of characteristic information between the respective components, and wherein the processor selects a component in which similarity of the characteristic information fulfills a prescribed condition, obtains a dynamic threshold value calculation method set for the component, and registers the dynamic threshold value calculation method in the dynamic threshold value calculation information as the dynamic threshold value calculation method for the received component.

Thus, according to the present invention, it is possible to shorten the time period required to calculate an appropriate threshold value and ensure that appropriate settings of the dynamic threshold value calculation method and parameter are made regardless of the experiences of the user.

### BRIEF DESCRIPTION OF THE DRAWINGS

FIG. 1 is a block diagram showing an example of a computer system according to an embodiment of the present invention.

FIG. 2 is a block diagram showing an example of a management server according to the embodiment of the present invention.

FIG. 3 is a block diagram showing an example of the storage according to the embodiment of the present invention.

FIG. 4A is a diagram showing an example of the attribute management table according to the embodiment of the present invention.

FIG. 4B is a diagram showing an example of the attribute management table according to the embodiment of the present invention.

FIG. 5A is a diagram showing an example of the related component management according to the embodiment of the present invention.

FIG. 5B is a diagram showing an example of the related component management table according to the embodiment of the present invention.

FIG. 6 is a diagram showing an example of the similar device configuration table according to the embodiment of the present invention.

FIG. 7 is a diagram showing an example of the similarity table according to the embodiment of the present invention.

FIG. 8 is a diagram showing an example of the threshold value table according to the embodiment of the present invention.

FIG. 9 is a diagram showing an example of the dynamic threshold value calculation method table according to the embodiment of the present invention.

FIG. 10 is a diagram showing an example of the component and performance value relation table according to the embodiment of the present invention.

FIG. 11 is a diagram showing an example of the parameter table according to the embodiment of the present invention.

FIG. 12 is a diagram showing a process to generate the similar device configuration table according to the embodiment of the present invention.

FIG. 13 is a diagram showing a process to generate the similar device configuration table according to the embodiment of the present invention.

FIG. 14 is a diagram showing a process to generate the similarity table from the similar device configuration table and select a similar component according to the embodiment of the present invention.

FIG. 15 is a flowchart showing an example of the process conducted by the management server according to the embodiment of the present invention.

FIG. 16 is a flowchart showing an example of a process to calculate the similarity, which is conducted in Step 3 of FIG. 15 according to the embodiment of the present invention.

FIG. 17 is a flowchart showing an example of a process to select a dynamic threshold value calculation method and parameter, which is conducted in Step S4 of FIG. 15 according to the embodiment of the present invention.

### DETAILED DESCRIPTION OF THE PREFERRED EMBODIMENTS

Below, an embodiment of the present invention will be explained with reference to appended figures.

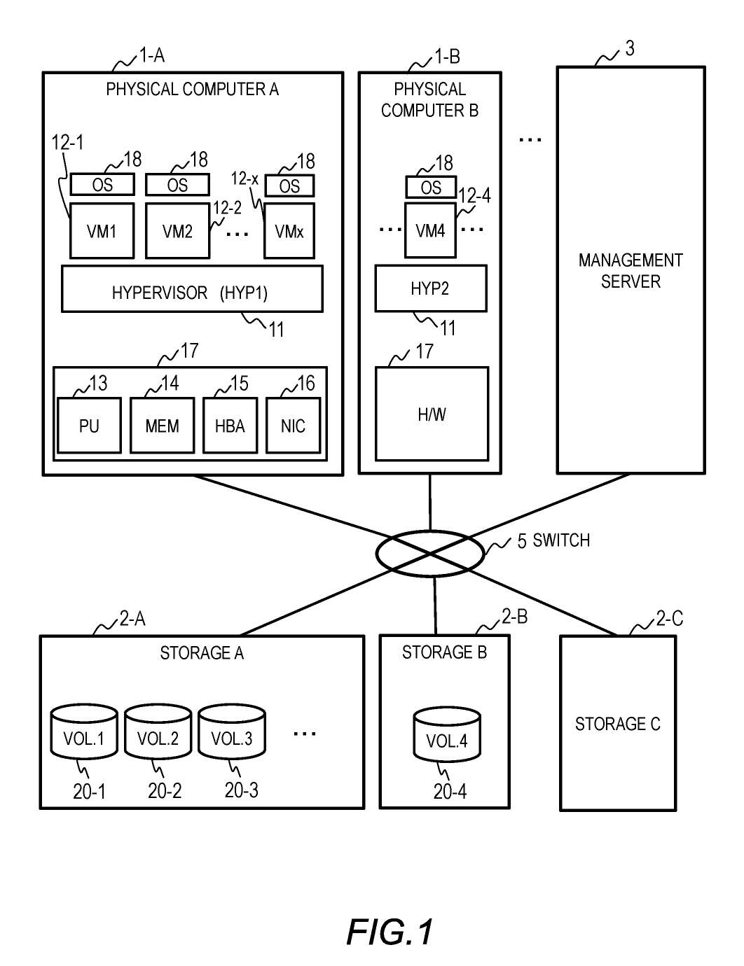

FIG. 1 is a block diagram showing an example of a computer system of an embodiment of the present invention.

The computer system includes physical computers 1-A and 1-B for operating one or more virtual machines 12-1 to 12-x, storages 2-A to 2-C for providing storage areas to the virtual machines 12-1 to 12-x, a management server 3 that manages the physical computers 1-A and 1-B and the storages 2-A to 2-C, and a switch 5 that mutually connects the physical computers 1-A and 1-B, the storages 2-A to 2-C, and the management server 3. Below, the physical computers 1-A and 1-B are collectively denoted with the reference character without a suffix connected by “-.” The same applies to other components.

The physical computer 1-A includes a hardware 17 including a processor 13, a memory 14, an HBA (host bus adapter) 15, and an NIC (network interface card) 16, a hypervisor 11 that virtualizes (or logically divides) the hardware 17 to be assigned to the virtual machines 12-1 to 12-x, and an OS 18 executed on the virtual machines 12. The physical computer 1-B has the same configuration.

The storage 2 provides volumes (VOL in the drawing) 20 as storage areas to the virtual machines 12 provided by the physical computers 1-A and 1-B. The configuration of the virtual machines 12 running on the physical computers 1 and the volumes 20 allocated to the virtual machines 12 are managed by the management server 3.

The switch 5 can be comprised of a plurality of switches that provide a network connecting the HBA 15 of the physical computer 1, the storage 2, and the management server 3, and a network connecting the NIC 16 of the physical computer 1 and the management server 3.

The management server 3 monitors the components of the computer system such as the virtual machines 12 and the volumes 20, and sets a threshold value for monitoring the corresponding component when the configuration is changed. The management server 3 of this embodiment sets a threshold value calculation method and parameter that can dynamically change the threshold value for each component. At a prescribed timing, the program for monitoring the computer system updates the threshold value with the threshold value calculation method and parameter set by the management server 3 and continues to monitor the component.

This embodiment shows an example in which the performance monitoring program for monitoring the performance of the components of the computer system uses the dynamic threshold value calculation method and parameter set by the management server 3. The dynamic threshold value calculation method and parameter set by the management server 3 is not only used for monitoring the performance, but also used as a threshold value calculation method and parameter for failure detection, configuration monitoring, surveillance for unauthorized access, and the like.

Generation of the virtual machine 12, assignment of the hardware 17, and allocation of the volume 20 to the virtual machine 12 may be executed by a server other than the management server 3.

### Overview of Dynamic Threshold Value Calculation Method

Below, the overview of the process to set the dynamic threshold value calculation method and parameter, which is performed by the management server 3 of this embodiment, will be explained.

When the management server 3 of this embodiment identifies a component for which the dynamic threshold value calculation method is to be set or updated upon occurrence of prescribed events (for example, when a component is added or changed), the management server 3 obtains characteristic information included in the component and a relation with other components.

Next, the management server 3 calculates the similarity of the characteristic information between the components from the characteristic information of the subject component based on those types of information. The management server 3 selects a component including a high degree of similarity based on the calculated similarity. Then the management server 3 applies the dynamic threshold value calculation method and parameter set for the selected component to the subject component.

The management server 3 calculates the threshold value of the subject component by the dynamic threshold value calculation method and parameter, and performs the performance monitoring of each component.

This makes it possible to shorten the time period required to calculate an appropriate threshold value and ensure that appropriate settings of the dynamic threshold value calculation method and parameter are made regardless of experiences of the user.

### Management Server

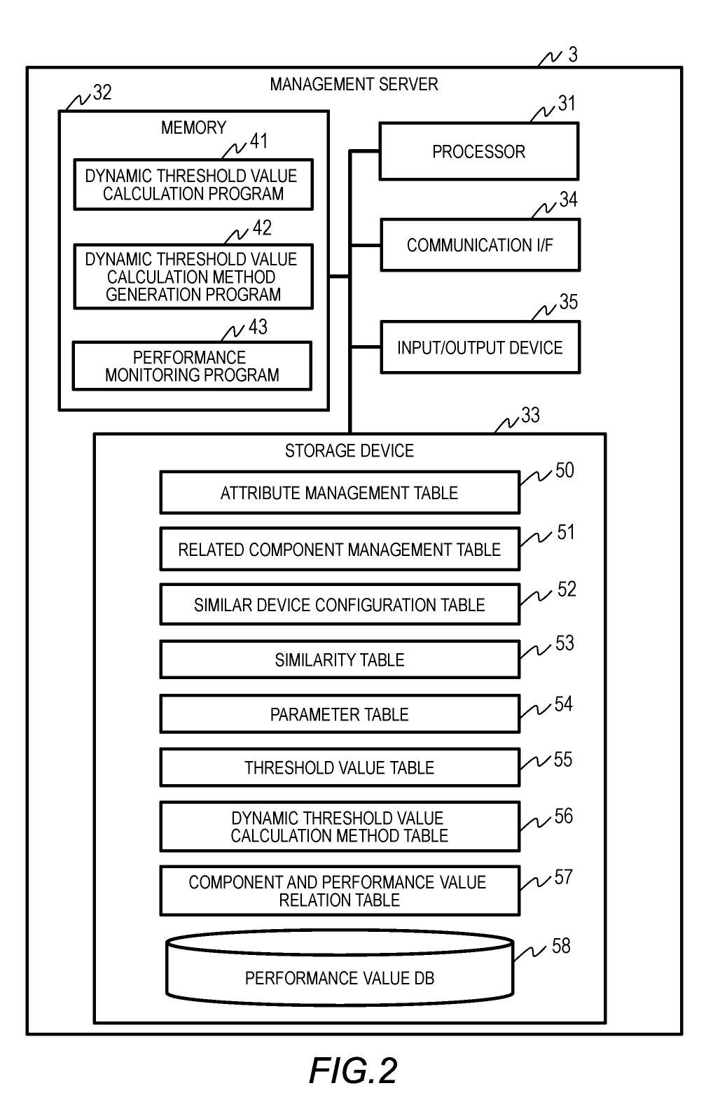

FIG. 2 is a block diagram showing an example of the management server 3. The management server 3 is a computer that includes a processor 31, a memory 32, a storage device 33, a communication I/F 34, and an input/output device 35.

A dynamic threshold value calculation program 41, a dynamic threshold value calculation method generation program 42, and a performance monitoring program 43 are loaded in the memory 32 and executed by the processor 31. The storage device 33 has stored therein tables used by the respective programs. The storage device 33 includes an attribute management table 50, a related component management table (component related information) 51, a similar device configuration table 52, a similarity table 53, a parameter table 54, a threshold value table 55, a dynamic threshold value calculation method table 56, a component and performance value relation table (performance value related information) 57, and performance value DB (performance information storage) 58. The respective tables will be described in detail later.

The communication I/F 34 is connected to the switch 5, and can communicate with respective devices on the network. The input/output device 35 is comprised of a keyboard, a mouse, a touch panel, or a display.

As will be described later, the dynamic threshold value calculation program 41 is called from the performance monitoring program 43 or the like at a prescribed timing, and dynamically updates the threshold table 55. As will be described later, the dynamic threshold value calculation method generation program 42, which is executed when a component is added or changed, calculates the similarity from the configuration information of the component for which the dynamic threshold value is to be set, and determines the dynamic threshold value calculation method and parameter of the subject component based on the similarity.

The performance monitoring program 43 obtains the performance information of each component, updates the performance value DB, and compares the performance value with the threshold value calculated by the dynamic threshold value calculation method. If the performance value satisfies a prescribed condition with respect to the threshold value, the performance monitoring program 43 executes prescribed processes such as resource allocation change and migration.

Information for realizing the respective functions of the management server 3 such as programs and tables can be stored in the storage device 33, a memory device such as a storage sub-system, a non-volatile semiconductor memory, hard disk drive, or SSD (solid state drive), or a computer readable non-temporary data storage medium such an IC card, SD card, or DVD.

### Storage

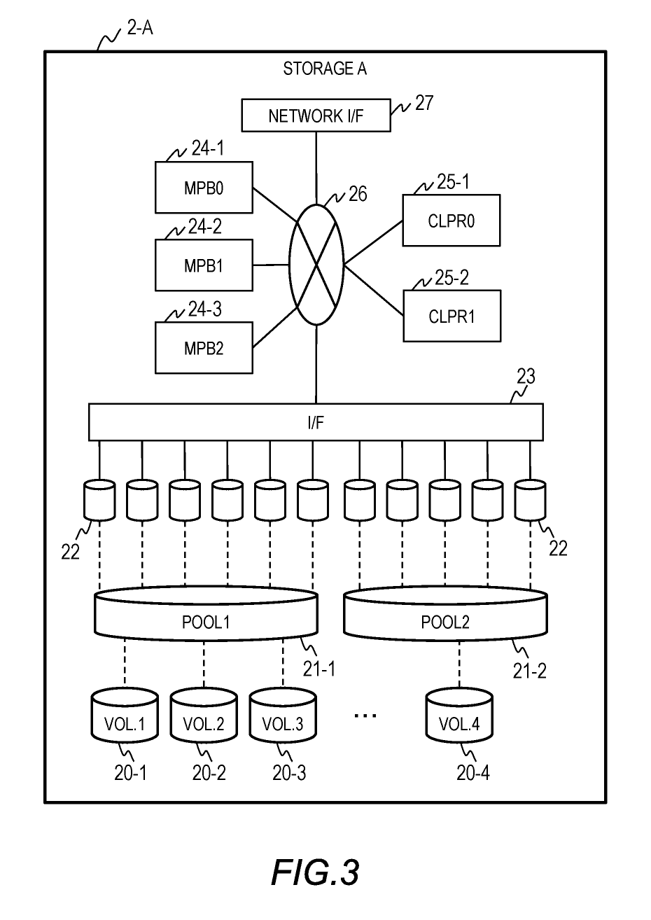

FIG. 3 is a block diagram showing an example of the storage 2-A. The storages 2-B and 2-C have the same configuration, and therefore, overlapping descriptions will be omitted.

The storage 2-A includes MPBs (Multiple Processor Blades) 24-1 to 24-3 functioning as a control unit, CLPRs (Cache Logical Partition) 25-1 and 25-2 controlling the shared memory, a network I/F 27 connected to the switch 5, an interface 23 connected to a plurality of storage devices 22, and an internal network 26 connecting these components to each other.

The storage 2-A can allocate the storage area of the physical storage devices 22 to logical storage areas (pool) 21-1 and 21-2. The storage 2-A generates volumes VOL1 to 4 (20-1 to 20-4) as virtual storage areas in response to a request from the management server 3 or the like from the logical storage areas allocated to the pools 21-1 and 21-2, and provides the volumes to the virtual machines 12 running on the physical computer 1. The virtual machine 12 mounts the volume VOL20 provided from the storage 2-A to read and write information.

In the example shown in the figure, the storage 2-A allocates the pool 1 (21-1) and the pool 2 (21-2) to the storage areas of the plurality of storage devices 22, and generates the volumes 1-3 (20-1 to 20-3) from the pool 1 (21-1), and the volume 4 (20-4) from the pool 2 (21-2).

### Tables

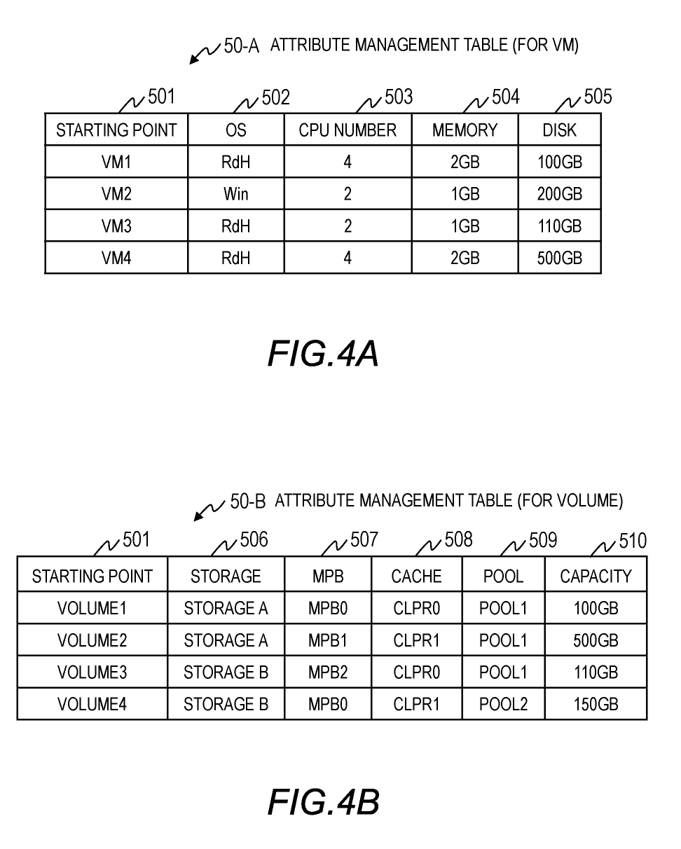

Below, each table stored in the storage device 33 of the management server 3 will be explained. FIG. 4A is a diagram showing an example of the attribute management table 50-A. FIG. 4B is a diagram showing an example of the attribute management table 50-B.

The attribute management table 50 is a table to be registered or updated when the management server 3 creates (or changes) a component to be monitored, and this embodiment describes an example in which the virtual machine 12 and the volume 20 are the components to be monitored. Because the respective types of components have different requirements such as performance, the attribute management table 50 have different formats for the respective types of components. The component to be monitored may be any logical (or virtualized) computer resource that can be generated, moved, stopped, or deleted while the computer system is in operation.

The attribute management table 50-A in FIG. 4A includes, in one entry, starting point 501 for storing an identifier of the virtual machine 12 (component), OS 502 for storing the type of the OS executed in the virtual machine 12, CPU number 503 for storing the number of cores of the processor 13 allocated to the virtual computer 12, memory 504 for storing the capacity of the memory 14 allocated to the virtual machine 12, and disk 505 for storing the capacity of the volume 20 allocated to the virtual machine 12.

In this embodiment, the virtual machine 12 is set in the starting point 501 as a component of the physical computer 1, and the OS 502 to the disk 505 are treated as the characteristic information indicating the characteristics of the virtual computer 12.

The attribute management table 50-B in FIG. 4B includes, in one entry, starting point 501 for storing an identifier of the volume 20, storage 506 for storing an identifier of the storage providing the volume 20, MPB 507 for storing an identifier of the MPB 24 used by the volume 20, CLPR 508 for storing an identifier of the CLPR 25 used by the volume 20, pool 509 for storing an identifier of the pool 21 that provides a storage area of the volume 20, and capacity 510 for storing the capacity allocated to the volume 20.

The attribute management table 50-A stores the information of the virtual machine 12 generated in the physical computer 1, and the attribute management table 50-B stores the information of the volume VOL20 generated in the storage 2.

In this embodiment, the volume VOL20 is set in the starting point 501 as a component of the storage 2, and the storage 506 to the capacity 510 are treated as the characteristic information indicating the characteristics of the volume VOL20.

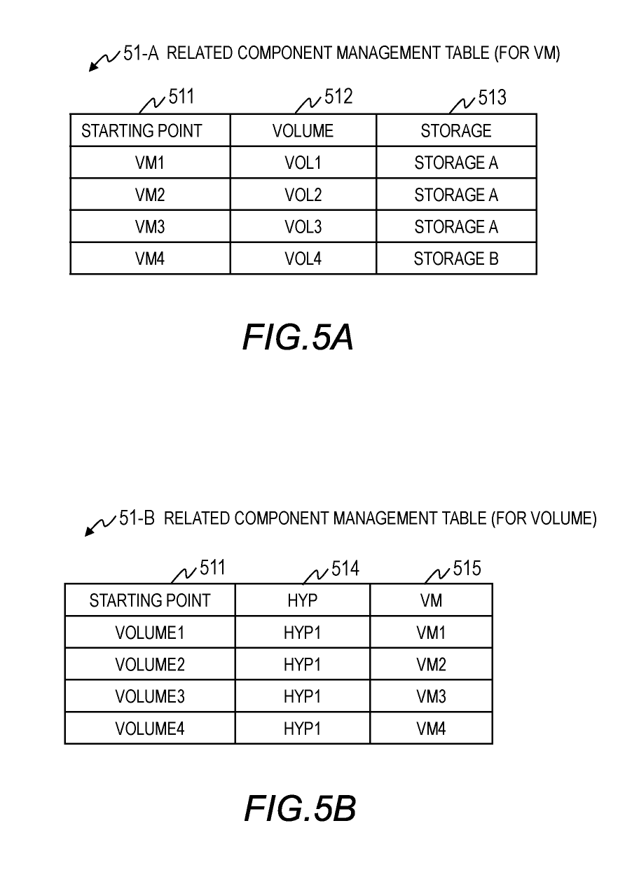

FIG. 5A is a diagram showing an example of the related component management table 51-A. FIG. 5B is a diagram showing an example of the related component management table 51-B.

The related component management table 51 is a table registered or updated when the management server 3 allocates the volume VOL20 to the virtual machine 12. In this embodiment, the related component management table 51-A is a table for specifying the storage of the volume VOL20 used by the virtual machine 12, and the related component management table 51-B is a table for specifying virtual machines 12 on the hypervisor 11 that is using the volume VOL20.

The related component management table 51-A in FIG. 5A includes, in one entry, starting point 511 for storing an identifier of the virtual machine 12, volume 512 for storing an identifier of the volume VOL20 allocated to the virtual machine 12, storage 51 for storing an identifier of the storage that provides the volume VOL20.

The related component management table 51-B in FIG. 5B includes, in one entry, starting point 511 for storing an identifier of the volume 20, HYP 514 for storing an identifier of the hypervisor 11 to which the volume VOL20 is allocated, and VM 515 for storing an identifier of the virtual computer 12 that is using the volume VOL20.

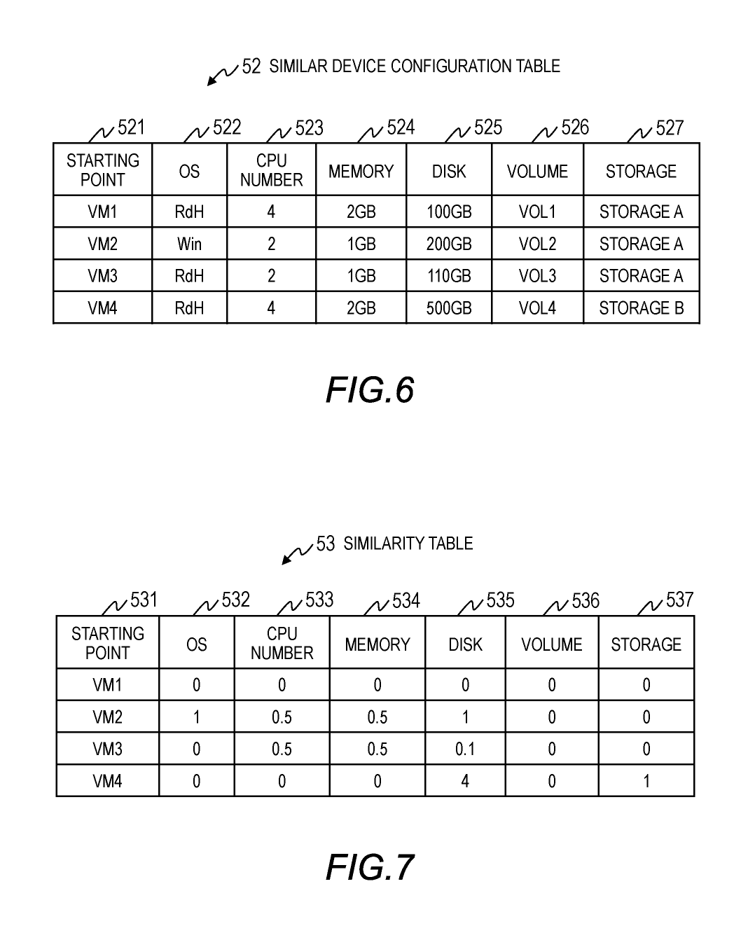

FIG. 6 is a diagram showing an example of the similar device configuration table 52. The similar device configuration table 52 is a table generated by the management server 3 when the virtual machine 12 is created and the volume VOL 20 is allocated.

The similar device configuration table 52 includes, in one entry, starting point 521 for storing an identifier of the virtual machine 12, OS 522 for storing the type of the OS running on the virtual machine 12, CPU number 523 for storing the number of cores of the processor 13 allocated to the virtual machine 12, memory 524 for storing the capacity of the memory 14 allocated to the virtual machine 12, disk 525 for storing the capacity of the volume VOL20 allocated to the virtual machine 12, volume 526 for storing an identifier of the volume VOL20 allocated to the virtual machine 12, and storage 527 for storing an identifier of the storage providing the volume VOL20.

The similar device configuration table 52 is a table combining the elements of the attribute management tables 50-A and 50-B based on the relationship between the virtual machine 12 and the volume VOL20 of the related component management table 51.

FIG. 6 shows an example in which an identifier of the virtual machine 12 is set in the starting point 521 as a component, but as will be described later, an identifier of the volume VOL20 can alternatively be set as a component.

Furthermore, in FIG. 6, an identifier of the volume VOL 20, which is a component related to the virtual machine 12 specified in the starting point 521, is stored in the volume 526. That is, one of the mutually related components can be set in the starting point 521, and the other component can be handled as characteristic information. This relationship between the component of the starting point and the component included in the characteristic information also applies in other tables.

FIG. 7 is a diagram showing an example of the similarity table 53. The similarity table 53 is a table for storing a degree of similarity of the configurations among the virtual machines 12 calculated by the management server 3. In the example shown in the figure, the similarity table 53 shows the similarity of virtual machines 12 (VM2 to VM4) with respect to the configuration of the virtual machine 12 (VM1). In this embodiment, the smaller the value, the more similar, and the greater the value, the less similar.

The similarity table 53 includes, in one entry, starting point 531 for storing an identifier of the virtual machine 12, OS 532 for storing the similarity of the type of the OS running on the virtual machine 12, CPU number 533 for storing the similarity of the number of cores of the processor 13 allocated to the virtual machine 12, memory 534 for storing the similarity of the capacity of the memory 14 allocated to the virtual machine 12, disk 535 for storing the similarity of the capacity of the volume VOL20 allocated to the virtual machine 12, volume 536 for storing the similarity of an identifier of the volume VOL20 allocated to the virtual machine 12, and a storage 537 for storing the similarity of an identifier of the storage providing the volume VOL20. The method to calculate the similarity will be described later.

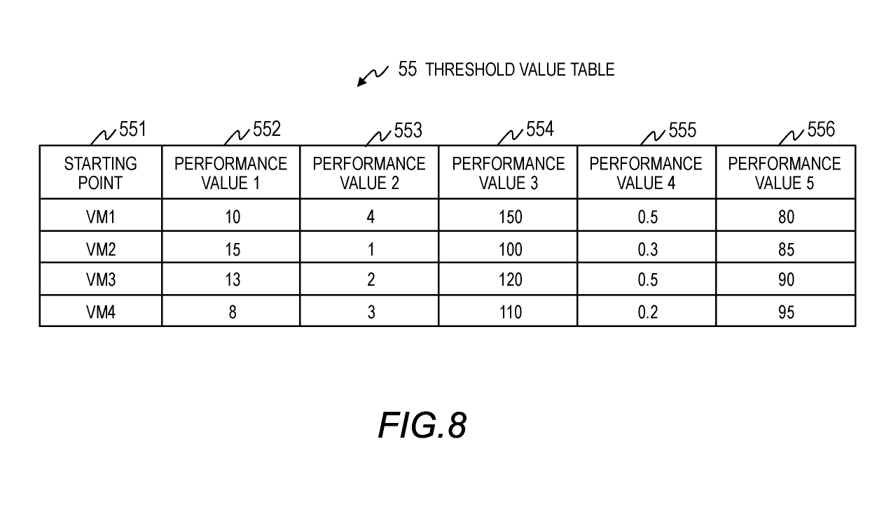

FIG. 8 is a diagram showing an example of the threshold value table 55. In the threshold value table 55, the management server 3 holds the values calculated by the dynamic threshold value calculation method and the parameter set in the dynamic threshold value calculation method table 56 and the parameter table 54 for each performance value of each component.

The threshold value table 55 includes, in one entry, starting point 551 for storing an identifier of the virtual machine 12, and performance value 1 (552) to performance value 5 (556) for storing a threshold value for each performance value.

The dynamic threshold value calculation program 41 of the management server 3 updates the threshold value table 55 by the dynamic threshold value calculation method at a prescribed timing. Then, the performance monitoring program 43 compares the performance value obtained from the component to be monitored with the threshold value of the threshold value table 55, and performs prescribed processes such as detection of resource shortage and failure.

As described later, in the performance value 1 (552) to the performance value 5 (556) of the threshold value table 55, the calculation results of the dynamic threshold value calculation method on the performance values 1 to 5 set in the dynamic threshold value calculation method table 56 are stored.

In addition, the management server 3 dynamically updates the threshold value table 55 by calculating a threshold value using a dynamic threshold value calculation method and parameter at a prescribed timing such as at a prescribed interval.

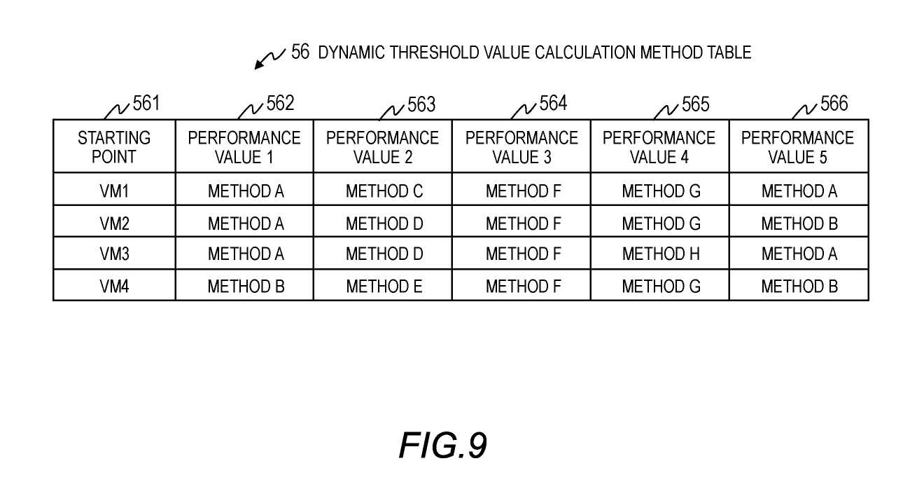

FIG. 9 is a diagram showing an example of the dynamic threshold value calculation method table 56. In the dynamic threshold value calculation method table 56, a calculation method selected by the dynamic threshold value calculation method generation program 42 of the management server 3 is set for each performance value 1 to 5.

The dynamic threshold value calculation method table 56 includes, in one entry, a starting point 561 for storing an identifier of the virtual machine 12 and performance value 1 (562) to performance value 5 (566) for storing a dynamic threshold value calculation method for each performance value.

As a dynamic threshold value calculation method, prescribed calculation methods, such as a method of removing outlier by LOF (Local Outlier Factor), a maximum value, an average filter (moving average) value, and a median filter value, are set as methods A to H in the figure.

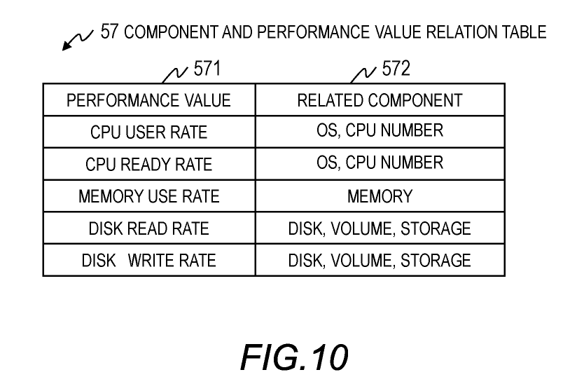

FIG. 10 is a diagram showing an example of the component and performance value relation table 57. The component and performance value relation table 57 is the information set in advance in the management server 3. The component and performance value relation table 57 includes, in one entry, performance value 571 for storing the name of the performance value, and related component 572 for storing the characteristic information of the component related to the performance value. The related component 572 stores one or more pieces of characteristic information included in the component.

In the example shown in the figure, “OS” and “CPU NUMBER” are defined for the related component 572 with the performance value 571 corresponding to “CPU Use Rate,” which means that the type of OS and the number of CPU are related to the use rate of the processor 31.

Similarly, “OS and “CPU” are defined for the related component 572 with the performance value 571 corresponding to “CPU Ready Rate,” which means that the type of OS and the number of CPU are related to the ready rate of the processor 31. “CPU Ready Rate” is the ratio of the time when the processor 31 allocated to the virtual machine 12 is in a standby state because of the conflict with other virtual machines 12.

The related component 572 corresponding to “Disk Read Rate” or “Disk Write Rate” is defined to be “Disk,” “Volume,” and “Storage.” Each row of the performance value 571 corresponds to the performance values 1 to 5 of the threshold value table 55 and the dynamic threshold value calculation method table 56.

As described above, by linking more than one types of characteristic information to one performance value, it is possible to set in detail the characteristic information subjected to the similarity comparison for each performance value as described below.

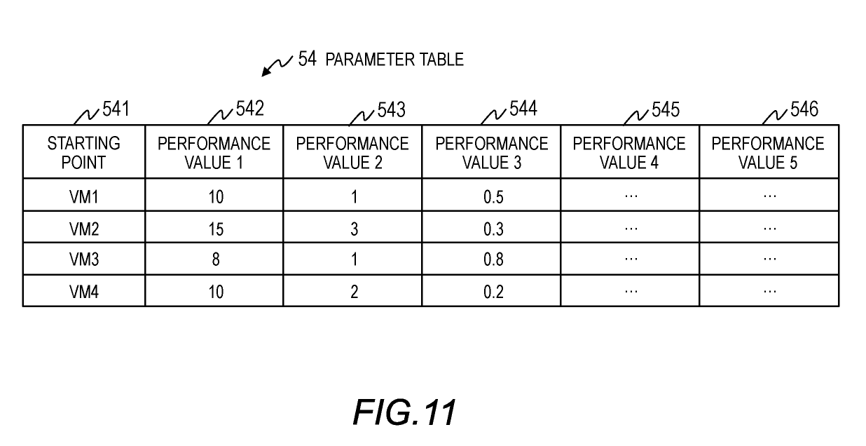

FIG. 11 is a diagram showing an example of the parameter table 54. The parameter table 54 stores therein the values selected by the dynamic threshold value calculation method generation program 42 of the management server 3.

The parameter table 54 includes, in one entry, starting point 541 for storing an identifier of the virtual machine 12, and performance value 1 (542) to performance value 5 (546) for storing a parameter for each performance value.

In the performance value 1 (542) to the performance value 5 (546), parameters to be used in the methods A to H of the dynamic threshold value calculation method table 56 of FIG. 9 are stored. Examples of the parameters include the initial value, cut-off value of the filter, and recalculation cycle, and one or more parameters can be stored in accordance with the methods A to H.

The performance value DB 58 stores performance values of the components to be monitored, which are obtained by the performance monitoring program 43 at prescribed intervals. For example, in the same format as the threshold table 55 and the dynamic threshold value calculation method table 56, the performance value DB 58 can store the performance values 1 to 5 in in chronological order, using the virtual machine 12 as an index.

### Process Overview

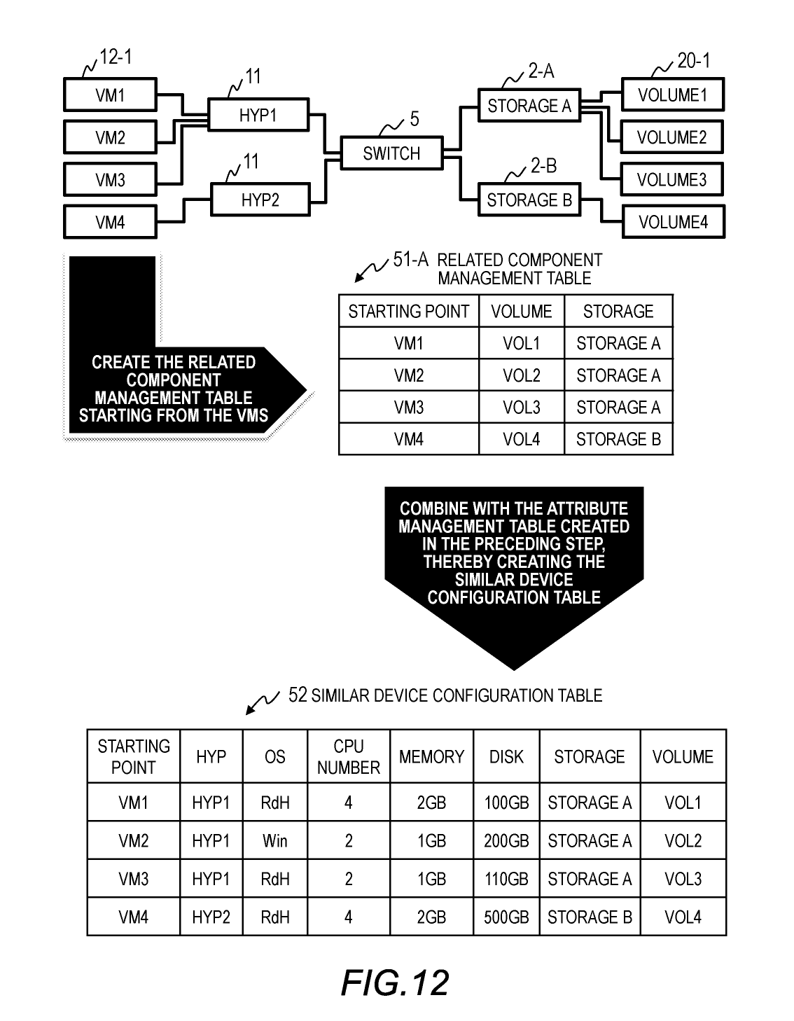

FIG. 12 is a diagram showing a process to generate the similar device configuration table. The example of the figure shows a process in which the management server 3 generates the similar device configuration table 52 when a virtual machine 12-1 (VM1) and a volume VOL1 (20-1) are added.

When the virtual machine 12-1 (VM1) is generated and the volume VOL 1 (20-1) is allocated to the virtual machine 12-1 (VM1), the management server 3 registers the virtual machine 12-1 in the attribute management table 50 and the related component management table 51.

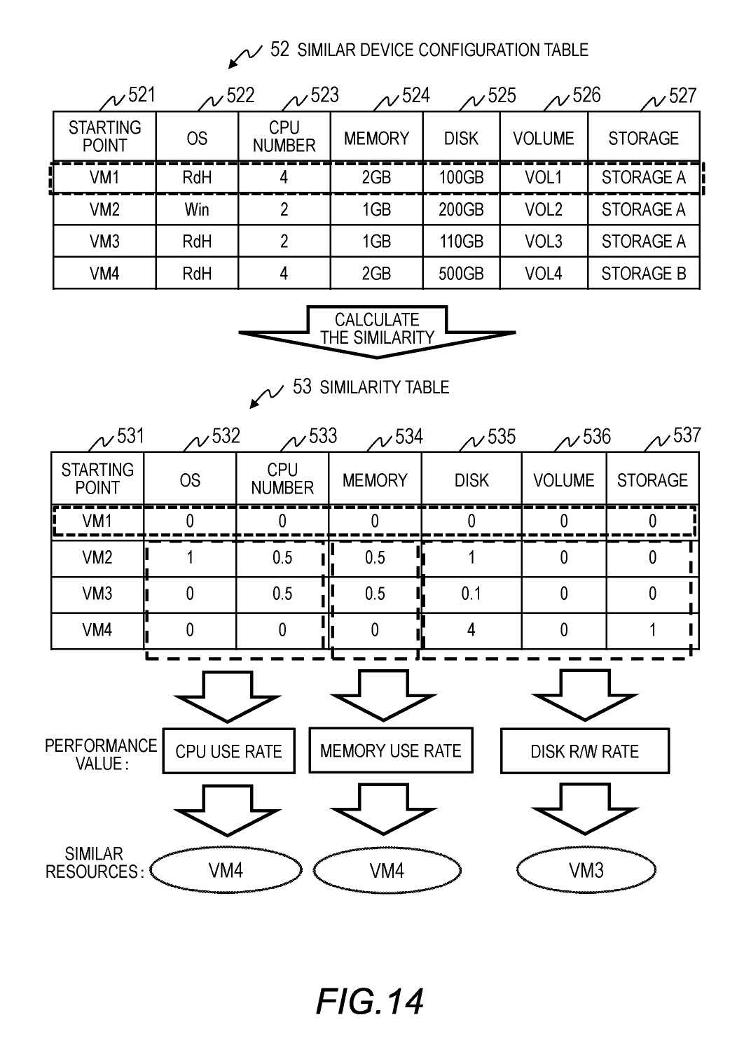

Next, the management server 3 obtains the relationship between the virtual machine 12 and the storage 2 of the volume VOL20 allocated to the added virtual machine 12 from the related component management table 51-A. The management server 3 obtains the characteristic information of the components of the attribute management tables 50-A and 50-B, and based on the relationship between the virtual computer 12 and the storage 2 of the volume VOL20 set in the related component management table 51-A, generates the similar device configuration table 52. Thereafter, the management server 3 calculates the similarity as shown in FIG. 14.

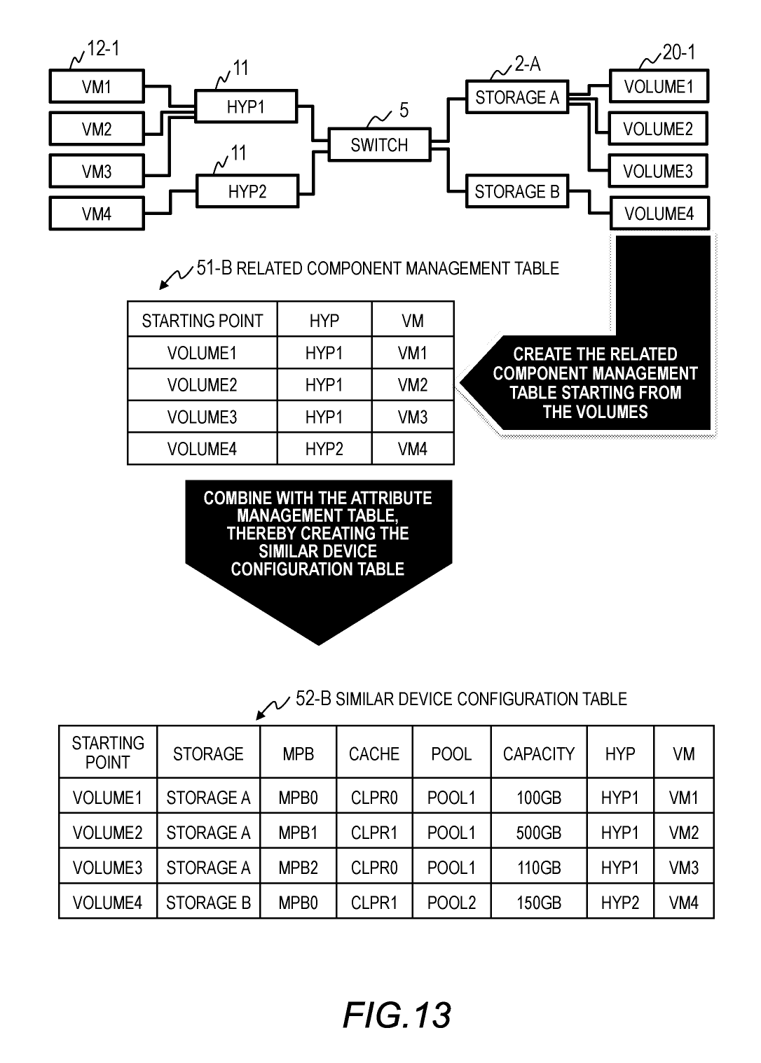

FIG. 13 is a diagram showing a process to generate the similar device configuration table. The example of the figure shows a process in which the management server 3 generates the similar device configuration table 52, starting from the volume VOL1 (20-1), when a virtual machine VM1 (12-1) and a volume VOL1 (20-1) are added.

The management server 3 obtains the relationship between the added volume VOL20 and the hypervisor 11 of the virtual machine 12 to which the volume VOL20 is allocated, from the related component management table 51-B. The management server 3 obtains the information of the components of the attribute management tables 50-A and 50-B, and based on the relationship between the volume VOL20 and the hypervisor 11 of the virtual machine 12 set in the related component management table 51-B, generates the similar device configuration table 52-B. Thereafter, in a manner similar to above, the management server 3 calculates the similarity as shown in FIG. 14.

Unlike the similar device configuration table 52 of FIG. 12, the similar device configuration table 52-B stores identifiers of the volume VOL20 in the starting point, and includes the columns of Storage, MPB, Cache, Pool, Capacity, HYP, and VM. It is possible to change the format of the similar device configuration table 52-B in accordance with the type of the component set in the starting point. The format of the similar device configuration table 52-B is set in advance depending on the type of the component.

FIG. 14 is a diagram showing a process to generate the similarity table 53 from the similar device configuration table 52 and select a similar component.

Based on the similar device configuration table 52 generated as shown in FIG. 12 (or FIG. 13) above, the management server 3 calculates the similarity of the characteristic information of the virtual machines VM2 to VM4 with respect to the added virtual machine VM1 (12-1) for each characteristic information of the virtual machines VM 2 to VM 4, and generates the similarity table 53.

Next, the management server 3 obtains the characteristic information for comparing the similarity between the respective components from the related component 572 of the component and performance value relation table 57. The figure shows an example in which the similarity of the characteristic information between the components is compared for three types of performance values.

If the performance value is “CPU USE RATE,” for example, the VM4, which has the smallest sum of the similarity of the OS 532 and the CPU number 533 of the similarity table 53, is selected as the most similar component. The management server 3 selects a similar component based on a plurality of performance values. If the performance values are “Memory Use Rate” and “DISK READ/WRITE RATE,” for example, the VM4, which has the smallest value in Memory 534, and the VM3, which has the smallest sum of the Disk 535, Volume 536, and Storage 537, are selected. The component with a higher degree of similarity is a component including a similarity level fulfilling prescribed conditions, and in this embodiment, that is a component with the smallest value of similarity.

The management server 3 selects the VM4, which is the most similar (including the smallest similarity value), out of the above selected components, and sets the dynamic threshold value calculation method (methods B, E, F, G, and B) and the parameter of VM4 as the dynamic threshold value calculation method of the virtual machine VM1 (12-1).

If there are a plurality of components that have been selected by comparing the similarity between a plurality of performance values, it is possible to select one dynamic threshold value calculation method and parameter, which are used most commonly for each of the performance value of each component, out of the plurality of dynamic threshold value calculation methods and parameters. This makes it possible to set the optimal dynamic threshold value calculation method and parameter based on the components with high similarity.

When there are a plurality of components that have been selected based on the similarity, a parameter that satisfies preset criteria, such as an average value of parameters set for these components and the most used value, may be selected.

Furthermore, the performance value for selecting the component based on the similarity does not have to be plural, and it is possible to specify a performance value to be used among the performance values set in the component and performance value relation table 57 (performance value related information).

The prescribed condition for selecting the component with high similarity is not limited to a component including the smallest similarity value, but the prescribed condition may include the similarity of other components connected to the component.

### Process Details

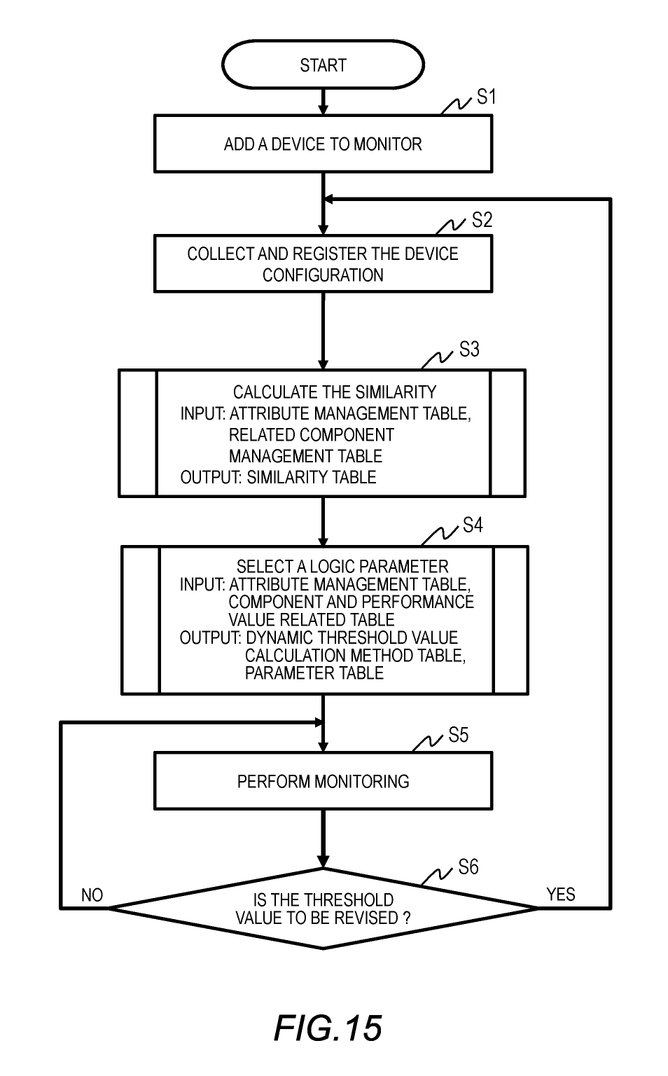

Next, the process conducted by the management server 3 will be explained in detail. FIG. 15 is a flowchart showing an example of the process conducted by the management server. This process is a process to be executed by the dynamic threshold value calculation method generation program 42 when a component to be monitored is added. This process may also be performed when a change is made to a component to be monitored.

When the component to be monitored is added (S1), the dynamic threshold value calculation method generation program 42 of the management server 3 accepts the attribute and the relation of the added component via the input/output device 35, and registers the component in the attribute management table 50 and the related component management table 51 (S2).

As shown in FIG. 12 or FIG. 13, the dynamic threshold value calculation method generation program 42 of the management server 3 calculates the similarity of the characteristic information of other components with respect to the characteristic information of the added component (S3).

The management server 3 reads the related component management table 51, determines combinations of components and the characteristic information, and combines the related component management table 51 with the attribute management table 50, thereby generating the similar device configuration table 52.

Thereafter, the management server 3 calculates the similarity of other components with respect to the added component for each characteristic information in the similar device configuration table 52, thereby generating the similarity table 53.

Next, as shown in FIG. 14, the management server 3 selects the most similar component based on the similarity of the characteristic information of the similarity table 53. The management server 3 then selects a dynamic threshold value calculation method and parameter for each performance value of the component from the dynamic threshold value calculation method table 56 and the parameter table 54 of the selected component, and enters the selected dynamic threshold value calculation method and parameter in the dynamic threshold value calculation method table 56 and the parameter table 54 as the dynamic threshold value calculation method and parameter for the added component (S4). Thereafter, the management server 3 calculates the threshold value of the added component based on the dynamic threshold value calculation method table 56 and the parameter table 54, and stores the threshold value in the threshold value table 55.

The management server 3 executes the performance monitoring program 43 in Step S5 to obtain the performance value, and stores the performance value in the performance value DB 58. Then, the performance monitoring program 43 compares the obtained performance value with the value of the threshold value table 55, and performs prescribed processes such as detection of resource shortage and failure.

In Step S6, the management server 3 determines whether an event that requires the dynamic threshold value calculation method to be revised has occurred or not. In an event that requires the dynamic threshold value calculation method to be revised has occurred (insufficient resource or failure), the process returns to Step S2, and the processes described above are repeated. On the other hand, if an event that requires the dynamic threshold value calculation method to be revised has not occurred, the process returns to Step S5, and continues to monitor the performance value.

As described above, when a component is added, the dynamic threshold value calculation method and parameter set for the component that is highly similar to the added component among the existing components are applied to the added component. This way, it is possible to shorten the time period required to derive the appropriate threshold value, and it is also possible to appropriately set the dynamic threshold value calculation method and parameter without relying on the experience of the user.

When the management server 3 initiates an operation, an administrator or the like may determine the dynamic threshold value calculation method for each of the performance values 1 to 5 of the dynamic threshold value calculation method table 56 to generate the threshold value table 55.

In addition to the process by the performance monitoring program 43, the determination process on whether the dynamic threshold value calculation method needs to be revised or not in Step S6 may be modified such that the process returns to Step S2 when an instruction from an administrator or the like is received to reflect the change to the component in each table, or such that the process is ended.

FIG. 15 above showed the example in which the component was added, but the same process as described above can be performed when a change is made to the component, and in that case, the characteristic information of the component to be monitored is received (S1), and after receiving the attribute and relation information of the changed component via the input/output device 35 and the like, the component is registered in the attribute management table 50 and the related component management table 51 (S2).

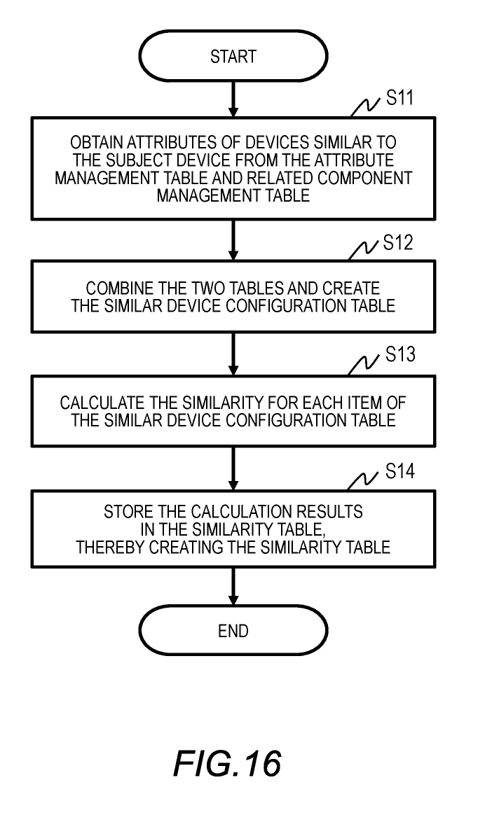

FIG. 16 is a flowchart showing an example of a process to calculate the similarity, which is conducted in Step 3 of FIG. 15. In Step S11, the management server 3 obtains the relationship between the respective components of the related component management table 51, and obtains the characteristic information of the related component from the attribute management table 50.

In Step S12, the characteristic information obtained from the attribute management table 50 by the management server 3 is combined with related components in the related component management table 51, thereby generating a similar device configuration table 52.

In Step S13, the management server 3 calculates the similarity for each characteristic information of the similar device configuration table 52. A known method can be used for the similarity calculation method, and for example, if the value of the characteristic information of the added component is D1 and the value of the characteristic information of the existing component is D2, the similarity can be calculated as follows:

Similarity=|D1−D2|/D1. If the value of each item of the component is a text, if D1=D2, the similarity is zero and if D1<>D2, the similarity is one.

In Step S13, the similarity of each characteristic information calculated from the similar device configuration table 52 by the management server 3 is stored in the columns of the similarity table 53, thereby generating the similarity table 53.

With the process described above, the management server 3 combines the information in the attribute management table 50 based on the relationship between the respective components of the related component management table 51, and generates the similar device configuration table 52. Then, by calculating the similarity based on the value of the characteristic information of the added component and the characteristic information of the columns of the existing components, the management server 3 can create the similarity table 53.

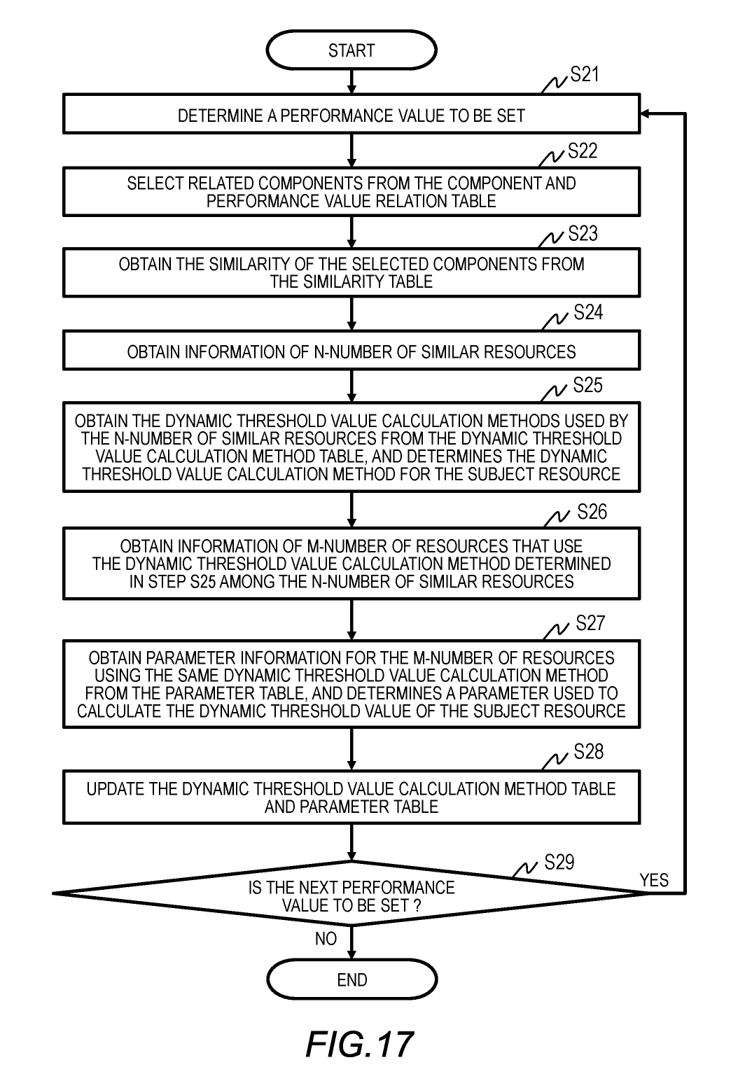

FIG. 17 is a flowchart showing an example of a process to select a dynamic threshold value calculation method and parameter, which is conducted in Step S4 of FIG. 15.

In Step S21, the management server 3 selects one of the performance values 1 to 5 not set in the dynamic threshold value calculation method table 56 for the added component. In this process, the management server 3 can select one performance value in the arrangement order of the columns or the like.

Next, in Step S22, the management server 3 refers to the component and performance value relation table 57, and obtains the characteristic information of the component related to the selected performance value. For example, when the performance value 571 of “CPU USE RATE” is selected, the management server 3 selects “OS” and “CPU number” as the characteristic information included in the component from the component and performance value relation table 57. Next, in Step S23, the management server 3 refers to the similarity table 53, and obtains the similarity of the selected characteristic information.

In Step S24, the management server 3 obtains the resource information for the selected component. In this embodiment, the similarity table 53 is the source of the resource information, and the management server 3 obtains n-number of pieces of similarity of the characteristic information of the selected component.

In Step S25, the management server 3 obtains the dynamic threshold value calculation method set in the performance value of the dynamic threshold value calculation method table 56 corresponding to the characteristic information of the most similar component (=including the smallest similarity value), and uses the dynamic threshold value calculation method for the added component.

In the case where a plurality of pieces of characteristic information are associated with one performance value (for example, OS and CPU number), the similarity of each characteristic information (OS 532 and CPU number 533) is tallied up, and an entry in the similarity table 53 with the smallest sum (total value) (Starting point 531=VM4) is selected. Then, the management server 3 selects an entry where the starting point 561 coincides with the starting point 531 from the dynamic threshold value calculation method table 56, and obtains the dynamic threshold value calculation method (method B) set in the characteristic information of the entry (VM4). The management server 3 sets the dynamic threshold value calculation method in the dynamic threshold value calculation method table 56 as the dynamic threshold value calculation method of the performance value to be set, which was selected in Step S21.

Next, in Step S26, the management server 3 obtains the resource information using the dynamic threshold value calculation method determined in Step S25. That is, the management server 3 selects m-number of entries including the dynamic threshold value calculation method determined in Step S25 in the column of the performance value of the dynamic threshold value calculation method table 56 corresponding to the performance value selected in Step S21.

In Step S27, the management server 3 obtains the starting point 531 of the m-number of entries selected in Step S26, and selects an entry in the parameter table 54 in which the starting point 541 matches the starting point 531 of the m-number of entries.

The management server 3 obtains the parameter set in the performance value (552 to 556) of the entry selected in the parameter table 54. Then the management server 3 sets the parameter in the parameter table 54 corresponding to the performance value to be set, which was selected in Step S21.

In Step S28, the management server 3 updates the dynamic threshold value calculation method table 56 and the parameter table 54. In Step S29, the management server 3 determines whether the added component still has a performance value to be set or not. In other words, if there is a performance value that has not been set, the process returns to Step S21 and the above process is repeated. If the dynamic threshold value calculation methods and the parameters have been set for all the performance values of the added component, the process is ended. After the process is ended, the management server 3 activates the dynamic threshold value calculation program 41, reads out the updated dynamic threshold value calculation method table 56 and parameter table 54, and dynamically updates the threshold value table 55 by calculating threshold values at a prescribed timing (at a prescribed interval, for example).

As described in FIG. 14, when there are a plurality of components (entries) selected based on the similarity of a plurality of performance values, it is possible to select the most used dynamic threshold value calculation method and parameter for the respective performance values of the respective components (entries). When there are a plurality of components (entries) selected based on the similarity, it is possible to select a parameter that fulfills preset criteria, such as the average value of the parameters set in the performance values of these components (entries) or the most used values.

As described above, according to this embodiment, when a component to be added or updated is received, the management server 3 updates the attribute management table 50 and the related component management table 51, generates the similar device configuration table 52 by determining combinations of the components and characteristic information based on the related component management table 51 and the attribute management table 50, and calculates the similarity of the characteristic information between the respective components based on the similar device configuration table 52. The management server 3 selects a component in which the similarity of the characteristic information meets a prescribed condition, obtains the dynamic threshold value calculation method set for the component from the dynamic threshold value calculation method table 56, and registers the dynamic threshold value calculation method in the dynamic threshold value calculation method table 56 as the dynamic threshold value calculation method for the received component.

As a result, by updating the threshold value table 55 using the dynamic threshold value calculation method table 56, it is possible to shorten the time period required to derive an appropriate threshold value of the dynamic threshold value, and also it is possible to set the optimal dynamic threshold value calculation method and parameter without relying on the experience of the user or administrator.

### Conclusion

As described above, in this embodiment, the dynamic threshold value calculation method and program used by the most similar component are set in the dynamic threshold value calculation method table 56 and the parameter table 54 of the component to be set. This makes it possible to shorten the time period required to derive an appropriate threshold value and to appropriately set the dynamic threshold value calculation method and the parameters without relying on the experience of a user such as an administrator of the computer system.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

### Appendix

The present invention may have the following configuration:

A storage medium that stores a program for controlling a computer including a processor and a memory, the storage medium being a non-temporary computer-readable storage medium that has stored therein a program for causing the computer to execute:

a first step of storing characteristic information of components in attribute information;

a second step of storing a connection relationship between respective components in component related information;

a third step of storing, in threshold value information, a threshold value for each performance information of the respective components;

a fourth step of setting, in dynamic threshold value calculation information, a dynamic threshold value calculation method for dynamically updating the threshold value for each performance information of the respective components;

a fifth step of storing characteristic information of components related to the performance information in performance related information;

a sixth step of receiving a component to be added or updated, and updating the attribute information and component related information;

a seventh step of determining combinations of components and characteristic information based on the component related information and the attribute information and calculating similarity of characteristic information between the respective components;

an eighth step of selecting a component in which the similarity of the characteristic information fulfills a prescribed condition; and

a ninth step of obtaining a dynamic threshold value calculation method set for the selected component, and registers the dynamic threshold value calculation method in the dynamic threshold value calculation information as the dynamic threshold value calculation method for the received component.

What is claimed is:

1. A management computer that comprises a processor and a memory and that is configured to monitor performance of components of a computer system, the management computer including:
attribute information that stores therein characteristic information of the components;
component related information that stores therein a connection relationship between the respective components;
threshold value information that stored therein a threshold value for each performance information of the respective components;
dynamic threshold value calculation information that stores therein in advance a dynamic threshold value calculation method for dynamically updating the threshold value for each performance information of the respective components; and
performance related information that stores therein in advance characteristic information of components related to the performance information,
wherein the processor receives a component to be added or updated, and updates the attribute information and the component related information,
wherein the processor determines combinations of components and characteristic information based on the component related information and the attribute information and calculate similarity of characteristic information between the respective components, and
wherein the processor selects a component in which similarity of the characteristic information fulfills a prescribed condition, obtains a dynamic threshold value calculation method set for the component, and registers the dynamic threshold value calculation method in the dynamic threshold value calculation information as the dynamic threshold value calculation method for the received component.

2. The management computer according to claim 1,
wherein the processor first tallies up similarity of characteristic information of the components based on performance value related information that defines a relationship between a prescribed performance value and characteristic information, and then selects a component in which similarity of the characteristic information fulfills a prescribed condition.

3. The management computer according to claim 2,
wherein the processor selects a plurality of components in which similarity fulfills a prescribed condition in a plurality of the performance values, and selects one of dynamic threshold value calculation methods set for the plurality of components.

4. The management computer according to claim 1, further including parameter information that stores therein in advance a parameter of a dynamic threshold value calculation method for dynamically updating the threshold value for each performance information of the respective components,
wherein the processor obtains the parameter set for a component in which the similarity fulfills a prescribed condition, and registers the parameter in the parameter information as the parameter for the received component.

5. The management computer according to claim 1,
wherein the processor receives a virtual machine as a component to be added, and adds, to the attribute information and the component related information as characteristic information, a volume allocated to the virtual machine.

6. The management computer according to claim 1,
wherein the processor receives a volume as a component to be added, and adds, to the attribute information and the component related information as characteristic information, a virtual machine to which the volume is allocated.

7. A performance monitoring method conducted by a management computer that comprises a processor and a memory for monitoring performance of components of a computer system, the performance monitoring method comprising:
a first step in which the management computer stores characteristic information of the components in attribute information;
a second step in which the management computer stores a connection relationship between the respective components in component related information;
a third step in which the management computer stores, in threshold value information, a threshold value for each performance information of the respective components;
a fourth step in which the management computer sets, in dynamic threshold value calculation information, a dynamic threshold value calculation method for dynamically updating the threshold value for each performance information of the respective components;
a fifth step in which the management computer stores characteristic information of components related to the performance information in performance related information;
a sixth step in which the management computer receives a component to be added or updated, and updates the attribute information and the component related information;
a seventh step in which the management computer determines combinations of components and characteristic information based on the component related information and the attribute information, and calculates similarity of characteristic information between the components;
an eighth step in which the management computer selects a component in which similarity of the characteristic information fulfills a prescribed condition; and
a ninth step in which the management computer obtains a dynamic threshold value calculation method set for the selected component, and registers the dynamic threshold value calculation method in the dynamic threshold value calculation information as the dynamic threshold value calculation method for the received component.

8. The performance monitoring method according to claim 7,
wherein, in the eighth step, the management computer first tallies up similarity of characteristic information of the components based on performance value related information that sets a relationship between a prescribed performance value and characteristic information, and then selects a component in which similarity of the characteristic information fulfills a prescribed condition.

9. The performance monitoring method according to claim 8,
wherein, in the ninth step, the management computer selects a plurality of components in which similarity fulfills a prescribed condition in a plurality of the performance values, and selects one of dynamic threshold value calculation methods set for the plurality of components.

10. The performance monitoring method according to claim 7, further comprising a step in which the management computer sets, in parameter information, a parameter of a dynamic threshold value calculation method for dynamically updating the threshold value for each performance information of the respective components;
wherein, in the ninth step, the management computer obtains the parameter set for a component in which the similarity fulfills a prescribed condition, and registers the parameter in the parameter information as the parameter for the received components.

11. The performance monitoring method according to claim 7,
wherein, in the sixth step, the management computer receives a virtual machine as a component to be added, and adds, to the attribute information and the component related information as characteristic information, a volume allocated to the virtual machine.

12. The performance monitoring method according to claim 7,
wherein, in the sixth step, the management computer receives a volume as a component to be added, and adds, to the attribute information and the component related information as characteristic information, a virtual machine to which the volume is allocated.

13. A computer system, comprising:
a management computer including a processor and a memory; and
a computer to be monitored by the management computer,
wherein the management computer includes:
attribute information that stores therein characteristic information of components in the computer;
component related information that stores therein a connection relationship between the respective components;
threshold value information that stores therein a threshold value for each performance information of the respective components;
dynamic threshold value calculation information that stores therein in advance a dynamic threshold value calculation method for dynamically updating the threshold value for each performance information of the respective components;
performance related information that stores therein in advance characteristic information of components related to the performance information; and
a performance information storage part that stores therein performance information obtained from the respective components,
wherein the processor receives a component to be added or updated, and updates the attribute information and the component related information,
wherein the processor determines combinations of components and characteristic information based on the component related information and the attribute information and calculate similarity of characteristic information between the components, and
wherein the processor selects a component in which similarity of the characteristic information fulfills a prescribed condition, obtains a dynamic threshold value calculation method set for the component, and registers the dynamic threshold value calculation method in the dynamic threshold value calculation information as the dynamic threshold value calculation method for the received component, and
wherein the processor calculates the threshold value based on the dynamic threshold value calculation information at a prescribed timing, and updates the threshold value information.

14. The computer system according to claim 13,
wherein the processor first tallies up similarity of characteristic information of the components based on performance value related information that sets a relationship between a prescribed performance value and characteristic information, and then selects a component in which similarity of the characteristic information fulfills a prescribed condition.

15. The computer system according to claim 14,
wherein the processor selects a plurality of components in which similarity thereof fulfills a prescribed condition in a plurality of the performance values, and selects one of dynamic threshold value calculation methods set for the plurality of components.
